(19) United States
(12) Patent Application Publication
(10) Pub. No.: US 2020/0154707 A1
(43) Pub. Date: May 21, 2020

(54) Preventing and Destroying Citrus Greening and Citrus Canker Using Rhamnolipid

(71) Applicant: Rhamnolipid, Inc., Tampa, FL (US)

(72) Inventor: Keith DeSanto, Tampa, FL (US)

(73) Assignee: Rhamnolipid, Inc., Tampa, FL (US)

(21) Appl. No.: 16/750,857

(22) Filed: Jan. 23, 2020

Related U.S. Application Data
(63) Continuation-in-part of application No. 15/899,873, filed on Feb. 20, 2018.
Application No. 15/899,873 is a continuation-in-part of application No. 15/899,494, filed on Feb. 20, 2018.
Application No. 15/899,494 is a continuation-in-part of application No. 15/946,049, filed on Apr. 5, 2018.
Application No. 15/946,049 is a continuation-in-part of application No. 15/946,277, filed on Apr. 5, 2018.
Application No. 15/946,277 is a continuation-in-part of application No. 15/945,978, filed on Apr. 5, 2018.
Application No. 15/945,978 is a continuation-in-part of application No. 16/514,208, filed on Jul. 17, 2019, now abandoned.
(60) Provisional application No. 62/521,616, filed on Jun. 19, 2017.
(60) Provisional application No. 62/517,264, filed on Jun. 9, 2017.
(60) Provisional application No. 62/521,616, filed on Jun. 19, 2017.
(60) Provisional application No. 62/521,616, filed on Jun. 19, 2017.
(60) Provisional application No. 62/517,264, filed on Jun. 9, 2017.
(60) Provisional application No. 62/521,616, filed on Jun. 19, 2017.
(60) Provisional application No. 62/714,139, filed on Aug. 3, 2018.

(51) Int. Cl. A01N 43/16; A01N 63/20; A01N 25/08

(52) U.S. Cl. CPC A01N 43/16; A01N 25/08; A01N 63/20

(57) ABSTRACT

Disclosed herein are Rhamnolipid compositions and their use in methods of preventing or minimizing the spread or transmission of pathogens, such as citrus greening, citrus canker, and citrus blackspot in plants, trees, or bushes.

### CROSS-REFERENCE TO RELATED APPLICATIONS

The present application is a continuation-in-part of U.S. patent application Ser. No. 15/899,873, filed on Feb. 20, 2018, which in turn claims the benefit of U.S. Provisional Patent Application No. 62/521,616, filed on Jun. 19, 2017, the contents of which are incorporated herein by reference in their entireties.

The present application is a continuation-in-part of U.S. patent application Ser. No. 15/945,978, filed on Apr. 5, 2018, which in turn claims the benefit of U.S. Provisional Patent Application No. 62/521,616, filed on Jun. 19, 2017, the contents of which are incorporated herein by reference in their entireties.

The present application is a continuation-in-part of U.S. patent application Ser. No. 15/946,049, filed on Apr. 5, 2018, which in turn claims the benefit of U.S. Provisional Patent Application No. 62/521,616, filed on Jun. 19, 2017, the contents of which are incorporated herein by reference in their entireties.

The present application is a continuation-in-part of U.S. patent application Ser. No. 15/899,494, filed on Feb. 20, 2018, which in turn claims the benefit of U.S. Provisional Patent Application Nos. 62/521,616, filed on Jun. 19, 2017, and 62/517,264, filed on Jun. 9, 2017, the contents of which are incorporated herein by reference in their entireties.

The present application is a continuation-in-part of U.S. patent application Ser. No. 15/946,277, filed on Apr. 5, 2018, which in turn claims the benefit of U.S. Provisional Patent Application No. 62/517,264, filed on Jun. 9, 2017, the contents of which are incorporated herein by reference in their entireties.

The present application is a continuation-in-part of U.S. patent application Ser. No. 16/514,208, filed on Jul. 17, 2019, which in turn claims the benefit of U.S. Provisional Patent Application No. 62/714,139, filed on Aug. 3, 2018, the contents of which are incorporated herein by reference in their entireties.

### FIELD

The present technology is generally related to Rhamnolipid compositions and their use in methods of preventing or minimizing the spread or transmission of pathogens, such as citrus greening, citrus canker, and citrus blackspot in plants, trees, or bushes.

### SUMMARY

In one aspect, a process includes injecting a formulation having a Rhamnolipid into the stem or root of a plant to cure a disease afflicting the plant. In some embodiments, the disease may be Citrus Greening. In some embodiments, the disease may be Citrus Canker. In some embodiments, the disease may be Citrus Blackspot.

In any of the above embodiments, the formulation further also a carrier. In any of the above embodiments, the carrier may be water. In any of the above embodiments, the formulation may be contained within a capsule. In any of the above embodiments, the Rhamnolipid includes a mono-Rhamnolipid and a di-Rhamnolipid, wherein an average molecular weight of the mono- and di-Rhamnolipid is from 475 g/mol to 677 g/mol. In any of the above embodiments, the Rhamnolipid may be in powered form.

In any of the above embodiments, the formulation may also include a liposome. In any of the above embodiments, the formulation may also include a peptide encapsulated in the liposome.

In any of the above embodiments, the injecting may include boring a hole into the root, stem, branch, or trunk of the plant.

In another aspect, a process includes contacting a Rhamnolipid with Xanthomonas axonopodis or Candidatus Liberibacter asiaticus wherein the Rhamnolipid breaks down a cell wall of the Xanthomonas axonopodis or Candidatus Liberibacter asiaticus.

In another aspect, a process includes identifying a plant exhibiting symptoms of Citrus Greening or Citrus Canker, injecting a Rhamnolipid into a stem or root of the plant, thereby preventing the Citrus Greening or Citrus Canker from spreading to other plants. In such embodiments, the process includes identifying a plant exhibiting symptoms of Citrus Canker, and injecting a capsule comprising a Rhamnolipid into a stem or root of the plant, thereby preventing Citrus Canker from spreading to other plants. In such embodiments, the process may include identifying a plant exhibiting symptoms of Citrus Greening, and injecting a capsule comprising a Rhamnolipid into a stem or root of the plant, thereby preventing Citrus Greening from spreading to other plants.

In another aspects, a process includes injecting, spraying, or soaking a formulation having a Rhamnolipid into the stem, root, trunk, leaves, or branch of a plant, tree or bush to cure a disease afflicting the plant. In some embodiments, the disease may be Citrus Greening. In some embodiments, the disease may be Citrus Canker. In some embodiments, the disease may be Citrus Blackspot.

In any of the above embodiments, the formulation further also a carrier. In any of the above embodiments, the carrier may be water. In any of the above embodiments, the formulation may be contained within a capsule. In any of the above embodiments, the Rhamnolipid includes a mono-Rhamnolipid and a di-Rhamnolipid, wherein an average molecular weight of the mono- and di-Rhamnolipid is from 475 g/mol to 677 g/mol. In any of the above embodiments, the Rhamnolipid may be in powered form.

In any of the above embodiments, the formulation may also include a fertilizer. In any of the above embodiments, the fertilizer includes a nitrogenous fertilizer, an organic nitrogenous fertilizer, a phosphate fertilizer, a potassium fertilizer, a compound fertilizer, or a complete fertilizer (NPK). In such embodiments, the soaking the formulation into the plant is by adding the formulation to the gravel or sand at the base of the plant.

In any of the above embodiments, the formulation may also include a liposome.

In another aspect, a method of inhibiting GNA Gyrase or Topoisomerise IV in a plant, the method including injecting into a stem or root of the plant a formulation comprising a Rhamnolipid and a peptide encapsulated in a liposome. In such embodiments, the peptide may be ParE3. In some such embodiments, the Rhamnolipid and peptide are encapsulated in the liposome. In the embodiments, the formulation may be in powered or aqueous form.

In another aspect, a method of treating or curing a disease afflicting a plant includes injecting, spraying, or soaking a mixture comprising a formulation comprising a Rhamnolipid and a peptide encapsulated in a liposome into the stem, root, trunk, leaves, or branch of a plant, tree or bush. In such embodiments, the peptide may be ParE3. In some such embodiments, the Rhamnolipid and peptide are encapsulated in the liposome. In the embodiments, the formulation may be in powered or aqueous form. In any of the above embodiments, the formulation may also include a fertilizer. In any of the above embodiments, the formulation may be applied by a drone.

In another aspect, a process includes binding or soaking seeds with a formulation comprising a Rhamnolipid to deter diseases or stop diseases from forming in the seeds. In such embodiments, the formulation may also include a liposome.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Citrus greening, also known as the Huanglongbing disease (abbreviated as HLB), or Yellow Dragon Disease, is a plant disease that is caused by infection of the plant with the bacteria Candidatus Liberibacter, also known as Candidatus Liberibacter asiaticus. Citrus greening may also be caused by the Asian citrus psyllid, Diaphorina citri. Citrus canker is also a bacterial disease in plants that is caused by the bacteria Xanthomonas axonopodis. Citrus blackspot is fungal disease in plants that is caused by Guignardia citricarpa. Citrus greening, citrus blackspot, and citrus canker typically are associated citrus trees, but they may also be found on non-citrus trees, plants, and bushes. The diseases are transmitted by the transmission of the relevant bacteria between plants by pests, wind, rain, and farming tools.

It has now been found that by injecting a Rhamnolipid formulation into a plant exhibiting symptoms of citrus canker, citrus blackspot, and/or citrus greening, the symptoms of the disease are substantially reduced or eliminated, thereby treating or successfully curing the plant of the infection. The process of injecting an infected plant with the Rhamnolipid formulation include injecting a capsule containing Rhamnolipid into the stem or root of the infected plant. The injection is intended to prevent the growth of a bacteria, fungus, or oomycote on the plant.

In some embodiments, the processes described herein of treating a plant exhibiting symptoms of various diseases includes contacting a Rhamnolipid formulation with Xanthomonas axonopodis, wherein the Rhamnolipid breaks down a cell wall of the Xanthomonas axonopodis. In such a process, by killing the Xanthomonas axonopodis, the disease is eradicated, cured, or at least controlled in the plant, where the disease is citrus canker. In other process, the Rhamnolipid formulation is contacted with Candidatus Liberibacter asiaticus bacteria to eradicate citrus greening in the plant.

Also disclosed herein are Rhamnolipid formulations that eliminate, or at least substantially reduce, citrus greening, citrus blackspot, and/or citrus canker in plants, trees and bushes. Without being bound by theory, it is believed that the Rhamnolipid acts against the bacteria by breaking down the cells walls of the bacteria. This action is believed to occur because Rhamnolipid(s) are amphiphilic (i.e. having hydrophilic and hydrophobic regions), and that characteristic may facilitate the entry of the Rhamnolipid into the cell membranes by breaking down the cell wall of bacteria, thus permeating the bacterial cell, and disrupting it from reproduction.

Rhamnolipids are glycolipids produced by various organisms, and they are recognized as being “green” or environmentally friendly due to their low environmental cytotoxicity. Rhamnolipids are, generally, biosurfactants and they may be produced via fermentation with Pseudomonas aeruginosa. However, they may also be produced by fermentations with Rhodotorula taiwanensis, Lactobacillus Plantarum, Pseudomonas Rhizophila, Pseudomonas Chlororaphis, and/or Burkholderia sp. The materials also have high emulsification potential and antimicrobial activities.

In some embodiments, an average molecular weight of the mono- and di-Rhamnolipids is from about 475 g/mol to about 677 g/mol.

The rhamnolipids may be in a powdered form or aqueous form, and with or without other carriers and additives. For example, in the powdered form, the 99.998% di-Rhamnolipid c10, c10 or 99.1% mono-Rhamnolipid are both light white color and should be mixed immediately under a hood in order to prevent contamination or spoiling of Rhamnolipid. For example, in the aqueous form, the 12.1/2% Rhamnolipid is a clear amber color whereas the 7% Rhamnolipid is light brown and the 3% Rhamnolipid is brown and cloudy in color. To prepare the aqueous form, the Rhamnolipid is dissolved in water/other chemicals when used as a wetting agent and can be mixed with tap water. As noted, the Rhamnolipid formulations may have other additives or carriers with them. Illustrative additives include, but are not limited to, fertilizers and other components used in pest, disease, virus, fungus, and weed control applications. Illustrative carriers include, but are not limited to, water, most synthetic “toxic,” and non-toxic carriers. In any of the embodiments herein of processes or formulations, the formulation that include Rhamnolipid may further include trace amounts of metals or metal ions. Illustrative metals or metal ions include, but are not limited to, Na, K, Ca, Mg, Fe, Mn, Cu, Co, Zn, or mixtures of any two or more thereof.

In some embodiments, the Rhamnolipid is provided as a formulation that includes a Rhamnolipid and a carrier. The Rhamnolipid may be present in the formulation at a concentration sufficient to inhibit, or prevent, the transfer of pathogens from an article contacted with the formulation to living and/or non-living items. The Rhamnolipid may include mono-Rhamnolipid, di-Rhamnolipid, or a mixture thereof. In some embodiments, the Rhamnolipid in the formulation includes from about 5 wt % to about 95 wt % mono-Rhamnolipid and about 95 wt % to about 5 wt % di-Rhamnolipid. This may include from about 0.01 wt % to about 99.99 wt % mono-Rhamnolipid and about 99.99 wt % to about 0.01 wt % di-Rhamnolipid, from about 20 wt % to about 80 wt % mono-Rhamnolipid and about 80 wt % to about 20 wt % di-Rhamnolipid, or from about 30 wt % to about 70 wt % mono-Rhamnolipid and about 70 wt % to about 30 wt % di-Rhamnolipid. In some embodiments, the Rhamnolipid in the formulation includes about 37 wt % mono-Rhamnolipid and about 63 wt % di-Rhamnolipid, about 40 wt % mono-Rhamnolipid and about 60 wt % di-Rhamnolipid, or about 50 wt % mono-Rhamnolipid and about 50 wt % di-Rhamnolipid. In some embodiments, the Rhamnolipid in the composition includes about 100 wt % mono-Rhamnolipid, or about 100 wt % di-Rhamnolipid. Other amounts and ranges for the mono- and di-Rhamnolipid may be used as well.

The formulation may include the Rhamnolipid at a concentration of about 1 ppm to about 10,000 ppm. This may include from about 1 ppm to about 10,000 ppm, from about 1 ppm to about 5,000 ppm, from about 1 ppm to about 1,000 ppm, from about 100 ppm to about 10,000 ppm, from about 100 ppm to about 5,000 ppm, or from about 100 ppm to about 1,000 ppm. In some embodiments, the Rhamnolipid is present from about 100 ppm to about 300 ppm, from about 200 ppm to about 400 ppm, from about 300 ppm to about 500 ppm, from about 400 ppm to about 600 ppm, from about 500 ppm to about 700 ppm, from about 600 ppm to about 800 ppm, from about 700 ppm to about 900 ppm, from about 800 ppm to about 1000 ppm, or from about 900 ppm to about 1100 ppm. The composition may also include the Rhamnolipid as powder form and may include the Rhamnolipid from greater than 0 wt % to 100 wt %. This may include from about 0.01 wt % to 100 wt %, about 1 wt % to about 100 wt %, about 5 wt % to about 100 wt %, or about 10 wt % to 50 wt %.

The formulation may also include other materials such as non-toxic agents, diluents, biosurfactants, and the like. The formulation may also include other materials such as liposomes. In some embodiments, the carrier is a solution, a gel, paste, powder, or a polymer. In some embodiments, the carrier includes water.

The formulation that includes Rhamnolipid may be administered by injecting the formulation into the stem, root, trunk, or branch of a plant, bush, or a tree. The injection may be accomplished by boring/drilling a hole into root, stem, trunk, or branch of a tree, followed by insertion of a capsule, liquid, or solid containing the Rhamnolipid formulation. In some instances, the formulation that includes Rhamnolipid with or without liposomes is injected into the stem, root, trunk, or branch of a plant, bush, or a tree for 3 months (every two weeks). If there is no visual improvement in the fourth month, then it is considered that the plant, bush, or tree is non-responsive to Rhamnolipid with and without liposomes. Then a formulation containing a peptide encapsulated in a liposome with a Rhamnolipid is injected into the stem, root, trunk, or branch of a plant, bush, or a tree for another 3 month period (every two weeks). If there is no visual improvement in the fourth month with application of peptide encapsulated in a liposome with a Rhamnolipid, then it is considered that the plant, bush, or tree is non-responsive to any treatment with Rhamnolipid and/or deceased. Through injection, it has been found that plants are cured to a greater extent, even where spraying or other application methods fail.

Alternatively, the formulation that includes Rhamnolipid may be administered by spraying the formulation to the stem, root, trunk, branch, or leaves of a plant, bush, or a tree. The formulation that includes Rhamnolipid may be administered by soaking the stem, root, trunk, branch, or leaves of a plant, bush, or a tree with the formulation. The formulation that includes Rhamnolipid may be administered by soaking the seeds with the formulation. The formulation that includes Rhamnolipid may also be administered by adding the formulation to the gravel or sand at the base of the stem or root of a plant, bush, or a tree.

The formulation that includes the Rhamnolipid may be administered to the tree as a solution, powder, or as a capsule. As a capsule it is meant that the Rhamnolipid as a solution or powder is placed into a gel-capsule and the capsule is inserted into a hole that is drilled into the root or stem of a tree infected by a bacteria or disease.

Generally, the Rhamnolipid is produced by fermenting a carbon source (e.g. soybean oil, soybean oil, glycerin, automotive waste oil, oil from tanker spills frying oil, oil olive, canola oil, spent (waste oil) and pressed agricultural waste) in a aqueous solution with one or more of the above described microorganisms. The fermentation proceeds with a nutrient rich solution that includes trace elements such as iron, zinc, cobalt, copper, and manganese. The fermentation is carried out at a temperature from about 30° C. to about 60° C., and for a time sufficient to convert the carbon sources to the Rhamnolipid. The temperature may be from about 35° C. to about 50° C., or from about 35° C. to about 40° C. The time that is sufficient for conversion of the carbon source may be from about 1 hour to 500 hours. This may include from about 50 hours to about 250 hours, from about 100 hours to about 200 hours, or from about 150 hours to about 300 hours. The stirring speed should be sufficient to minimize foaming of the broth. For example, the stirring speed may be between about 100 and about 700 revolutions per minute, including about 100, about 200, about 300, about 400, about 500, about 600, or about 700 revolutions per minute. After fermentation, the Rhamnolipid broth that is obtained is acidified and then extracted with a suitable solvent such as, but not limited to ethyl acetate. In some instances, the preparation of the Rhamnolipid does not require extraction with a suitable solvent. The solvent may then be removed to provide the Rhamnolipid as a powder, which may then be used as such, or mixed with other additives and/or carriers.

The purity of the Rhamnolipid so obtained may be from about 1% to about 99%, from about 10% to about 99%, from about 20% to about 99%, from about 30% to about 99%, from about 40% to about 99%, from about 50% to about 99%, from about 60% to about 99%, from about 70% to about 99%, from about 80% to about 99%, or from about 90% to about 99%.

The Rhamnolipid may further include a liposome that is either mixed with the Rhamnolipid or is used to encapsulate the Rhamnolipid. As noted above, rhamnolipids have both a hydrophilic end and a hydrophobic end. Liposomes generally have such constituent compounds, and they form a double-walled hollow sphere or “vesicle” where the Rhamnolipid may be located. In aqueous solution, the double-wall is formed in a first, outer layer where the hydrophilic end (or “head” group) aligns near a surface of the vesicle, and the hydrophobic end (or “tail” group) aligns near an inner surface. The hydrophobic tails of a second, inner layer are then aligned with the hydrophobic tails of the first, outer, while the hydrophilic heads point to the center of the vesicle. Thus, the rhamnolipids may be mixed with a liposome or encased within the liposome. Liposomes are commercially available from sources such as the College of Nanobioengineering center, College of Marine Biology, and College of Pharmacy, USF Tampa, Fla. Liposomes used herein may be synthetic, natural, or a combination thereof.

Where rhamnolipids and liposomes are used in conjunction with one another, the liposome may be used to encapsulate various peptides for delivery to plant. Exemplary peptides includes those that are commercially available from USF Tampa, Fla., such as ParE3.

Where the liposome encapsulates a peptide and a Rhamnolipid is mixed with the liposome or is also encompassed by the liposome, the material may be used to eliminate, control, or at least reduce citrus greening, citrus canker, or both citrus greening and citrus canker.

An illustrative peptide that may be used in conjunction with the liposome and Rhamnolipid is ParE3. ParE3 is a synthetic peptide synthesized from the ParE protein. ParE3 is a toxin in a type II toxin-antitoxin system. ParE3 inhibits DNA Gyrase and Topoisomerase IV (Topo IV) activities, blocking the DNA bacterial replication and regulating its cell growth for new antimicrobial applications. However, there are natural blockades from allowing the peptide to enter a cell through the cell membrane. Because Rhamnolipid has both hydrophilic and hydrophobic components, the Rhamnolipid and liposome combination facilitates the entry of the peptide into cell membranes in such situation, and thus, cell permeability is enable by using the combination of the Rhamnolipid, liposome, and peptide. It has been found that when using peptides with rhamnolipids and liposomes, microbial inhibition is realized.

In some embodiments, a peptide encapsulated in a liposome with a Rhamnolipid is used for household anti-microbial applications. In some embodiments, bacteria and fungus that are resistant to current anti-microbial treatments are responsive to the peptide encapsulated in a liposome with a Rhamnolipid.

In some embodiments, a peptide encapsulated in a liposome with a Rhamnolipid is used to substantially reduce or eliminate, thereby treating or successfully curing the symptoms of any one of the diseases described herein in a plant, tree, or bush. In some embodiments, a peptide encapsulated in a liposome with a Rhamnolipid is used to substantially reduce or eliminate pathogens in a plant, tree, or bush. The peptide encapsulated in a liposome with a Rhamnolipid may be applied to the plant, bush, or tree by injection, spraying, or soaking as described herein.

The Rhamnolipid compositions described herein may further comprise a fertilizer. A fertilizer as described here are compositions contain nutrients that are important for plant growth and productivity. Fertilizers are divided into three classes based on the nutrients they provide: the primary macronutrients are nitrogen (N), phosphorus (P), and potassium (K); the secondary macronutrients are calcium (Ca), magnesium (Mg), and sulfur (S); and the micronutrients are iron (Fe), manganese (Mn), copper (Cu), zinc (Zn), boron (B), and molybdenum (Mo). As used herein, a composition is a fertilizer if the composition includes any one or more of the macronutrients or micronutrients as described herein. In some embodiments, garlic can also be used as a fertilizer. The Rhamnolipid compositions described herein may enhance the absorption of the nutrients from the fertilizer into the plant.

Non-limiting examples of fertilizer include nitrogenous fertilizers, organic nitrogenous fertilizers, phosphate fertilizers, potassium fertilizers, compound fertilizers, and complete fertilizers (NPK). Nitrogenous fertilizers are fertilizers that have nitrate, ammonia, ammonium salts, compounds with nitrogen in the amide form, or plant and animal byproducts. Examples of nitrogenous fertilizers include fertilizers comprising any one of sodium nitrate, ammonium sulfate, ammonium nitrate, ammonium chloride, urea, and calcium ammonium nitrate. Organic nitrogenous fertilizers are fertilizers comprising plant and animal by-products, such as animal waste, plant wastes from agriculture, compost, and products from the slaughter of animals. Phosphate fertilizers are fertilizers containing natural phosphates, treated phosphates, by-product phosphate, or chemical phosphates. Examples of phosphate fertilizers include fertilizers comprising rock phosphate, super phosphate, basic slag, or bone-meal. Potassium fertilizers are fertilizers that are used to provide potash to soils that are potash deficient. Examples of potassium fertilizers include fertilizers comprising potassium chloride, potassium sulfate, potassium carbonate, or potassium nitrate. Compound fertilizers refer to fertilizers comprising two or three plant nutrients, such a one containing both nitrogen and phosphorus. Complete fertilizers are fertilizers that contain all three primary macronutrients nitrogen, phosphorus, and potassium.

Non-limiting examples of fertilizers completed for use include, but are not limited to, fertilizers from Sta-Green® Scotts®, Ironite®, Pennington®, and Purely Organic Products™ and non-toxic fertilizers.

The Rhamnolipid compositions comprises a fertilizer in an amount of from about 0.005% to about 9.5% wt.

The Rhamnolipid compositions, such as those that further comprise a liposome, may be bound to seeds. Applying the Rhamnolipid compositions to the seeds may deter diseases or stop diseases from forming in the seeds. In some embodiments, the seeds are soaked with the Rhamnolipid composition (this step is also known as inoculation). Then the seeds may be pierced with suitable pressure to avoid damaging the seed, such that the Rhamnolipid composition may enter into the seed (this step is also known as treating). A suitable machine is used to apply the suitable pressure for piercing.

In another aspect, drones may be used to administer the Rhamnolipid compositions described herein. In some embodiments, the drones may spray or inject the Rhamnolipid compositions onto the seeds, plants, bushes, and trees.

In another aspect, the full process of identifying the disease and treating it is also claimed. Such embodiments include, identifying a plant exhibiting symptoms of citrus greening or citrus canker, injecting a capsule that includes a Rhamnolipid formulation into a stem or root of the plant, thereby preventing, curing, or at least treating the citrus greening and/or citrus canker, or preventing or minimizing the spread of the disease to other plants. In some embodiments, the process includes identifying a plant exhibiting symptoms of citrus canker, and injecting a capsule comprising a Rhamnolipid into a stem or root of the plant, thereby preventing citrus canker from spreading to other plants. In yet other embodiments, the process includes identifying a plant exhibiting symptoms of citrus greening, and injecting a capsule comprising a Rhamnolipid into a stem or root of the plant, thereby preventing citrus greening from spreading to other plants.

In identifying citrus greening in a plant, the hallmarks of the disease are: misshapen, unmarketable, bitter fruit that is typically green in color in ripened fruit; reduction in the quantity and quality of citrus fruits, unsuitable fruit for sale as fresh fruit or for juice; a blotchy leaf mottle and vein yellowing that develop on leaves attached to shoots showing the overall yellow appearance; symptoms that may superficially resemble a zinc deficiency although the green and yellow contrast is not as vivid with greening as it is with zinc deficiency; leaves that have a mottled appearance that differs from nutrition-related mottling, and/or DNA analysis to confirm citrus greening.

In identifying citrus canker in a plant, the hallmarks of the disease are: leaf-spotting and fruit rind-blemishing; fruit and stem lesions; shoot dieback; fruit drop; leaf lesions, pinpoint spots that may attain a size of 2 to 10 mm diameter; a yellow halo that surrounds lesions; and a water-soaked margin that develops around necrotic tissue.

In identifying citrus blackspot in a plant, the hallmarks of the disease are: hard spot (lesions that are small, round, sunken with gray centers and brick-red to chocolate brown margins); green halos surrounding the hard spot lesions; fungal structures that present as slightly elevated black dots in the center of lesions and which appear as fruit begins to color where light exposure is greatest; false melanose is observed as numerous small, slightly raised lesions that can be tan to dark brown, and it may occur on green fruit and does not have pycnidia (fungal structures); cracked spot has large, flat, dark brown lesions with raised cracks on their surface; early virulent spot, also known as freckle spot, has small reddish irregularly shaped lesions; and lesions on the leaf and stem that begin as small reddish brown lesions that are slightly raised, and with age they become round sunken necrotic spots with gray centers and prominent margins that are brick-red to chocolate brown.

In another aspect, the Rhamnolipid may further include a liposome to form a Rhamnolipid-liposome. As noted above, rhamnolipids have both a hydrophilic end and a hydrophobic end. Liposomes generally have such constituent compounds, and they form a double-walled hollow sphere or “vesical.” In aqueous solution, the double-wall is formed in a first, outer layer where the hydrophilic end (or “head” group) aligns near a surface of the vesicle, and the hydrophobic end (or “tail” group) aligns near an inner surface. The hydrophobic tails of a second, inner layer are then aligned with the hydrophilic tails of the first, outer, while the hydrophilic heads point to the center of the vesical. Thus, the rhamnolipids themselves are capable of forming the liposome, or Rhamnolipid-liposome. Where Rhamnolipid-liposomes are formed, they may be used to encapsulate various peptides for delivery to plant.

Where the Rhamnolipid-liposome encapsulates a peptide, the material may be used to eliminate, control, or at least reduce citrus greening, citrus canker, or both citrus greening and citrus canker.

The present invention, thus generally described, will be understood more readily by reference to the following examples, which are provided by way of illustration and are not intended to be limiting of the present invention.

### EXAMPLES

### Example 1

General Rhamnolipid production. The production medium consisted of a Ca-free mineral salt solution with 15.0 g/L NaNO₃, 0.5 g/L MgSO₄×7 H₂O, 1.0 g/L KCl, and 0.3 g/L K₂HPO₄. As sole carbon source soybean oil with a starting concentration of 250 g/L was used and 1 mL/L of the above-mentioned trace element solution was added. The trace element solution contained 2.0 g/L sodium citratex2H₂O, 0.28 g/L FeCl₃×6 H₂O, 1.4 g/L ZnSO₄×7 H₂O, 1.2 g/L CoCl₂×6 H₂O, 1.2 g/L CuSO₄×5 H₂O, and 0.8 g/L MnSO₄×H₂O. The fermentation was carried out at 37° C., pH 6.9, and the process was carried out for 158 h. The Rhamnolipid produced was purified by acidification and then an extraction was carried out using ethyl acetate. The ethyl acetate is then removed to leave the Rhamnolipid as a powder.

### Example 2

In the study, 3 trees infected with citrus greening were treated with Rhamnolipid. Into each of the trees was drilled an 18-inch deep hole using a ⅜ inch cement drill at a 45° angle, 2 feet above the soil line. A 12 oz. water bottle was then prepared by inserting a ⅜ inch rubber hose through the cap and sealed with silicone. The water bottle was then filled with an 8% (w/v) of a 50/50 mono- to di-Rhamnolipid. After inserting the rubber hose at least 12 inches into the hole, the bottle was inverted and affixed to the tree. The bottle was re-filled every week and a half, and some leakage of the Rhamnolipid from the bottle and the hole was observed.

### Example 3

In this study, 8 trees infected with citrus greening were tested, as well as 1 control tree that was not infected. The trees were split into groups for injection of Rhamnolipid, slow drip of Rhamnolipid, or pouring of Rhamnolipid. For injection, the tree were subjected to pressurized trunk injection (1.68 oz.) of the Rhamnolipid formulation using an Arborjet. For slow drip, a 7 oz. bottle was used as in Example 2 to slowly drip the Rhamnolipid into a hole in the trunk (½ inch hole), and the bottle was filled weekly or bi-weekly. For pouring, 1 gallon of the Rhamnolipid formulation was poured onto the roots around the tree. The Rhamnolipid formulation used was Alfred 8% 47/PA 55 gallons and has about 33 wt % mono-Rhamnolipid and about 66 wt % di-Rhamnolipid. The tests were initiated in August, three months prior to the budding of the trees, when the trees were at 25% in leaf and every 2 weeks after that for 3 months. It was found that for optimal results (better tasting fruit and visual inspection for symptoms of citrus greening) surrounding humidity of at least 60% is preferable. The trees treated with injection (drilling or Arborjet) responded better than soil treatments. Some trees took up to 1 year after the 3 month treatment to show improvement.

### Example 4

Initial studies have demonstrated that garlic can enhance the activity of the rhamnolipids. Any one of the Rhamnolipid formulations described herein is mixed with about 0.5% wt garlic, which is crushed, diced, or finely chopped. The resulting formulation containing Rhamnolipid is used for any one of the applications described herein.

### Example 5

Liposomes are commercially available from the College of Nanobioengineering center, College of Marine Biology, and College of Pharmacy, USF Tampa, Fla.

### Example 6

Rhamnolipid and liposome production. To incorporate the Rhamnolipid within a liposome, the liposomes were prepared in a phosphate buffer solution (“PBS”) (pH 7.2-7.4) with a final combination of Rhamnolipid, cholesterol, and phosphatidylcholine concentration determined by Table 1. First, each lipid was solubilized in chloroform, the solvent was evaporated by N₂, and in a vacuum bomb for 18 hours, to eliminate any chloroform residues. Then, the obtained films were hydrated with PBS solution (pH 7.2-7.4), the samples were vortexed and sonicated for 6 minutes by 21% of amplitude or extruded 30 times in a 0.1 gm membrane.

TABLE 1
Composition of the vesicles.

| | Rhamnolipid | Cholesterol | Phosphotidyl |
|---|---|---|---|
| Formulation | (mmol/L) | (mmol/L) | Choline (mmol/L) |
| A | 2.6 | 0 | 0 |
| B | 2.6 | 0 | 0.3 |
| C | 2.6 | 0.1 | 0 |
| D | 2.6 | 0.1 | 0.3 |

1. Dynamic light scattering (DLS) was used to measure the particle size and polydispersity of liposomes composed by formulations A, B, C and D. The DLS (Zetasizer—Malwern) was used at 173°, at controlled temperature (25±1° C.). Electrophoretic mobility of liposomes was measured by Zeta Potential, using the dynamic light scattering (Zetasizer—Malvern). The morphology and organization of liposomes were evaluated by TEM. For this study, samples were placed on a cooper grid and observed by using the staining-negative technique, where a drop of 1% (w/v) aqueous solution of uranyl acetate was added. The samples were imaged under a transmission electron microscope (JEOL JEM-100CX2) with an acceleration of 100 kv. The diameter of the liposomes was then determined by ImageJ software.

### Example 7. Synthesis, Purification and Identification of Peptides

LCParE3 was synthesized using a Solid Phase Fmoc (protecting group) strategy using a Rink-Amide MBHA resin (CAS 431041-83-7) and activated by DIC (N,N′-Diisopropylcarbodiimide) and tert-butanol. The resultant material was acetylated with acetic anhydride. The cleavage was done with a TFA (trifluoroacetic acid)/water/EDT (1,2-ethanedithiol)/thioanisole (94:2.5:2.5:1) and diethyl ether. After cleavage, LCParE3 was purified by reverse phase high performance liquid chromatography (HPLC) using a C18 column. Finally, the peptide was identified by mass spectrometry (ESI-MS Ion trap). To all experiments we used 100 μM of LCParE3.

### Example 8. Physical and Chemical Measures of Liposomes

Dynamic light scattering (DLS) was used to measure the particle size and polydispersity of liposomes composed by formulations A, B, C, and D. The DLS (Zetasizer—Malwern) was used at 173°, at a controlled temperature of (25±1° C.). Electrophoretic mobility of liposomes was measured by Zeta Potential, using the DSL. The morphology and organization of liposomes were evaluated by TEM (tunneling electron microscopy). For this study, samples were placed on a cooper grid and observed by using the staining-negative technique, where a drop of 1% (w/v) aqueous solution of uranyl acetate was added. The samples were imaged under a transmission electron microscope (JEOL JEM-100CX2) with an acceleration of 100 kv. The diameter of the liposomes was then determined by ImageJ software.

### Example 9. Efficiency of Encapsulation (EE %)

The efficiency of encapsulation (EE¾) study was to evaluate by AMICON® (50 kDa) centrifugation at 14.000×g during 14 minutes. Non-encapsulated peptide was able to cross the membrane and the solution was monitored by UV-Vis (280 nm). The concentration of peptide was evaluated using a LambertBeer curve and efficiency of encapsulation was calculated by: X=(Non-encapsulate Concentration Peptide×100)/(Initial Concentration of Peptide).

### Example 10. Microbiological Assays

To determine the growth cell inhibition of Escherichia coli O157: H17 (ATCC 43895) and Staphylococcus aureus (ATCC 14458) by rhamnolipids liposomes entrapped with LCParE3 a National Committee for Clinical Laboratory Standards (CLSI, 2006) microdilution method was used.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A process comprising injecting a formulation comprising a Rhamnolipid into the stem or root of a plant to cure a disease afflicting the plant.

2. The process of claim 1, wherein the disease is Citrus Greening.

3. The process of claim 1, wherein the disease is Citrus Canker.

4. The process of claim 1, wherein the disease is Citrus Blackspot.

5. The process of claim 1, wherein the formulation further comprises a carrier.

6. The process of claim 6, wherein the carrier is water.

7. The process of claim 1, wherein the formulation is contained within a capsule.

8. The process of claim 1, wherein the Rhamnolipid comprises a mono-Rhamnolipid and a di-Rhamnolipid, wherein an average molecular weight of the mono- and di-Rhamnolipid is from 475 g/mol to 677 g/mol.

9. The process of claim 1, wherein the Rhamnolipid is in powered form.

10. The process of claim 1, wherein formulation further comprises a liposome.

11. The process of claim 10, wherein the formulation further comprises a peptide encapsulated in the liposome.

12. The process of claim 1, wherein the injecting comprises boring a hole into the root, stem, branch, or trunk of the plant.

13. A process comprising injecting, spraying, or soaking a formulation comprising a Rhamnolipid into the stem, root, trunk, leaves, or branch of a plant, tree, or bush to cure a disease afflicting the plant, wherein the disease is Citrus Greening, Citrus Canker, or Citrus Blackspot.

14. A method of treating or curing a disease afflicting a plant comprising injecting, spraying, or soaking a mixture comprising a formulation comprising a Rhamnolipid and a peptide encapsulated in a liposome into the stem, root, trunk, leaves, or branch of a plant, tree or bush.

15. The method of claim 14, wherein the peptide is ParE3.
